(19) United States
(12) Patent Application Publication
(10) Pub. No.: US 2014/0078257 A1
(43) Pub. Date: Mar. 20, 2014

(54) Method for visualization of three-dimensional objects on a person

(71) Applicant: Hübner GmbH, (US)

(72) Inventors: Daniel Hübsch, Kassel (DE); Konstantinos Nalpantidis, Hagen (DE); Frank Platte, Hagen (DE); Thorsten Sprenger, Lohfelden (DE)

(73) Assignee: Hubner GmbH, Kassel (DE)

(21) Appl. No.: 13/815,259

(22) Filed: Feb. 14, 2013

(30) Foreign Application Priority Data
Feb. 18, 2012 (DE) DE 10 2012 003 32
Mar. 27, 2012 (DE) DE 10 2012 006 67

(51) Int. Cl. H04N 13/02; H04N 5/33

(52) U.S. Cl. CPC H04N 13/0253; H04N 5/33
USPC 348/46

(57) ABSTRACT

A method is provided for visualization of three-dimensional objects on a person. Electro-magnetic radiation is emitted toward a person. Electro-magnetic radiation reflected by the person is received and processed to obtain a three-dimensional representation in a form of an elevation profile of the person. If the elevation profile has a detected surface with a reflection coefficient that is different from a reflection coefficient of at least one neighboring surface and the detected surface has a stepped transition toward at least one neighboring surface, then the object characterized by the detected surface is projected onto a photographic representation of the person in the place where the detected surface has been detected.

### CROSS REFERENCE TO RELATED APPLICATIONS

This application claims priority from DE 10 2012 003 322.2, filed Feb. 18, 2012, and DE 10 2012 006 670.8, filed Mar. 27, 2012, the entire contents of both of which are incorporated herein in their entirety.

### FIELD OF THE INVENTION

The invention relates to a method and a device for visualization of three-dimensional objects on a person. Three-dimensional objects hereby refer to weapons, e.g. guns or knives.

### BACKGROUND OF THE INVENTION

The use of the method mentioned above belongs to the field of surveillance technology. It is already known to scan persons by means of millimeter or sub-millimeter waves, also called Terahertz waves in order to detect objects hidden on the body. Hereby, the body surface is a surface which has a certain reflection coefficient, which is why the electromagnetic radiation traces the contours of the body in a relatively accurate manner. In this respect, these scanners are also called full-body scanners. Scanning persons by means of such a full-body scanner however intrudes far into the private sphere of the individual persons.

Terahertz technology for scanning persons is nevertheless a technology with which it is possible to inspect persons with regard to hidden objects, without causing damage or diseases to the scanned persons, even if they are frequently forced to undergo such scanning processes, for example in the case of frequent fliers. In this respect, the details of the implementation of this technology in order to obtain a three-dimensional representation of the person to be inspected is already part of the prior art. In this context, reference is made for example to US 2009/0271146 A1. In order to scan a person, it is hereby more specifically provided to dispose the emitter and the receptor in the room in such a manner that the person is captured by the Terahertz signal or the terahertz radiation from several directions. In this respect, a multistatic configuration of several emitters, which are oriented toward the person to be scanned from different directions, forms the basis for a high resolution 3D representation of such a person in an elevation profile. The generation of a three-dimensional image or of an elevation profile in three dimensions occurs through multistatic scanning of the Fourier space and a subsequent topographic reconstruction. As has already been explained, this is part of the known prior art.

The generated three-dimensional representation or the elevation profile of such a person now allows seeing the skin surface, though indistinctly.

### SUMMARY OF THE INVENTION

The object of the invention is a method for visualization of three-dimensional objects, more specifically weapons, e.g. guns or knives, on a person, wherein the private sphere of the person is preserved. This means that the naked representation of a person on a screen is to be avoided.

According to an embodiment of the present invention, the body of the person is first scanned from several spatial directions, more specifically from three spatial directions. This occurs by pointing an electromagnetic radiation, more specifically in the millimeter or sub-millimeter range, onto the person from different directions, wherein several receptors are also provided in order to receive the reflected radiation in such an active system. Hereby, it is not absolutely necessary to provide several emitters in order to irradiate the body of the person to be examined from different directions; it is rather also conceivable to provide one single emitter, wherein the radiation emitted by the emitter completely captures the body by way of a corresponding mirror arrangement and the reflected radiation is received by corresponding sensors disposed in the room, in order to generate a three-dimensional representation, i.e. a elevation profile of the examined person. This elevation profile of the examined person, which has been generated through processing of the reflected radiation by means e.g. of multistatic scanning of the Fourier space and topographic reconstruction, is now not immediately represented on a screen but is examined in terms of whether the elevation profile has a surface that has a reflection coefficient that is higher than at least one neighboring surface and with which this surface has a stepped transition to at least one neighboring surface. When such surfaces have been detected, the object under this surface is projected as an elevation profile onto a photographic representation of the person at the location at which the surface has been detected. From this it becomes clear that the body is not only scanned by means of electromagnetic radiation in the millimeter and sub-millimeter range, but that a photographic representation of the person is immediately generated in order to subsequently project the detected object onto this photographic representation. This image is then shown to the screener on the screen. This image is an ethically clean representation that does not intrude in any way into the private sphere of the person to be inspected.

The object can also be projected onto a three-dimensional representation of the person instead of a two-dimensional photograph. To this end, a two-dimensional image is first superimposed onto a 3-D representation as a elevation profile of the person, wherein the initially two-dimensional image receives the 3-D contour of the elevation profile. It has been shown that a picture of the detected object, e.g. a gun, with a sharper contour can be generated hereby on the representation of the person.

By means of the method according to the invention, such objects can be detected that have a reflection coefficient that is different from that of the skin and the surface or surfaces of which furthermore have a stepped transition toward at least one neighboring surface. A stepped transition hereby refers to a transition between a first place on the first surface and a second place on the second surface, wherein the distance in height between the two places is greater than the lateral distance between the two places. Since metal for example has a substantially greater reflection coefficient than skin, weapons made of metal, such as e.g. knives or guns can be made visible in this respect. It has already been explained that an elevation profile of the body can be generated through terahertz technology. The body itself comprises a number of wave-shaped transitions, for example at the knees, in the area of the chest etc. Apart from the reflection coefficient, another restrictive criterion is whether the detected surface with a reflection coefficient that is higher than the neighboring surface, also has a stepped transition toward at least one neighboring area. The body itself only has soft transitions. This means that in the strict sense, steps are alien to the physiognomy of the body. This means that when stepped transitions to a surface with a high reflection coefficient are detected, it can be assumed with sufficient certainty that it is an object that is not part of the body. Such objects are then projected onto a photographic representation of the person, namely exactly in that place in which the detected object is located on the body of the inspected person. It is then up to the viewer to evaluate whether it is a weapon or another object.

Further advantageous features and embodiments of the invention can be gathered from the claims.

Thus, it is more specifically provided that the detected surface is contoured by way of a so-called edge detection method. Such algorithms for edge detection, e.g. the maximum gradient method by Sobel, are also known from the prior art. If a detected object, the surface of which is defined by the two previously mentioned conditions, is detected, this edge detection method allows to determine a representation of the object with sharp contours, which will in the end facilitate the evaluation by the viewer.

In parallel or in addition to this there is a possibility of determining volumes in a body by way of volume rendering, marching cubes and ray casting.

Another criterion for choosing such a surface can be the form of the surface. When the surface is substantially even, it can be assumed with high probability that this surface is not part of the body.

Whether the surface is a surface having an elevation profile with a maximum value is also a conceivable decision criterion. This means that weapons, such as e.g. a gun, have a certain height, which, when correspondingly positioned on the body of the inspected person, can set on the body in such a manner that this surface, e.g. of the gun, lies higher than all the other surfaces. The prerequisite for generating an elevation profile above the body of the patient is of course defining the zero level for calculating the elevation profile. The zero level is usually that level which is located approximately in the middle of the body as seen from above.

Moreover, the type of the object may be determined by feeding the contour of the detected surfaces to an automatic object identification method. Such object recognition methods are also known; hereby, a number of objects for example, in the present case, weapons, are stored in a database in a computer memory, wherein the computer makes a comparison to determine which of the stored object can be matched with which probability to the detected surface-based representation.

Another object of the invention is a device for visualization of three-dimensional objects on a person, wherein the device comprises at least one emitter and at least one receiver for electro-magnetic radiation, wherein the emitter emits an electro-magnetic radiation toward the person to be inspected and the receiver receives the electro-magnetic radiation reflected by the person, wherein a computer unit is provided, wherein the computer unit generates a three-dimensional representation of the person in form of an elevation profile by means of multistatic scanning of the Fourier space and topographic reconstruction.

### BRIEF DESCRIPTION OF THE INVENTION

The patent or application file contains at least one drawing executed in color. Copies of this patent application or patent application publication with color drawings will be provided by the Office upon request and payment of the necessary fee.

In the following, the invention will be exemplarily explained in more detail based on the drawings.

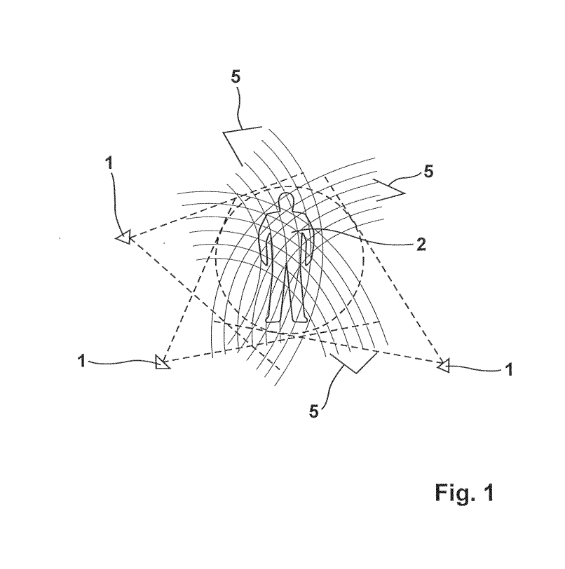

FIG. 1 is a schematic showing the scanning of a person in a three-dimensional space;

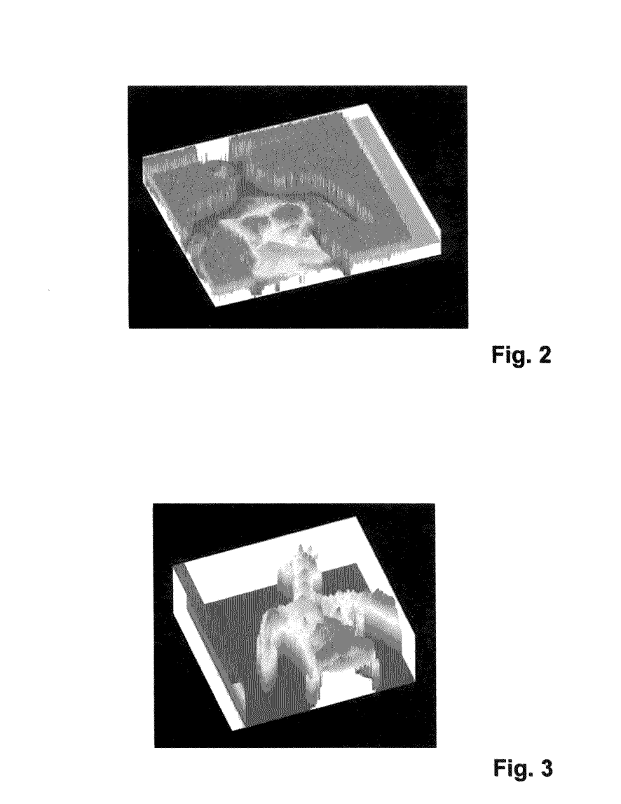

FIG. 2 exemplarily shows the elevation profile of a person; and

FIG. 3 shows a representation according to FIG. 2, wherein the surfaces of maximum reflection have been extracted.

### DETAILED DESCRIPTION OF THE INVENTION

The construction of a visualization device is shown in FIG. 1. Three sensors 1, the coverage angles of which overlap, are located in a three-dimensional space. The person 2 to be inspected is located in the center of the overlap. Different emitters 5 are moreover provided, which emit a corresponding electro-magnetic radiation in the millimeter or sub-millimeter range, which are then detected by the sensors. Through multistatic scanning of the Fourier space with subsequent topographic reconstruction, a three-dimensional representation in form of an elevation profile can then be generated, such as in the object of FIG. 2. In FIG. 2 the contours of the body are already relatively well-recognizable; the locations of objects alien to the body are also visible. In the representation according to FIG. 2, a gun is exemplarily located below the chest. The representation according to FIG. 2 is however still characterized by considerable noise. By using corresponding filters, a representation according to FIG. 3 can be generated, wherein the representation according to FIG. 3 shows surfaces of maximum reflection, the weapon hereby showing very clearly. A precise contouring of the weapon occurs when the so-called step filter is laid over this representation, i.e. when a computer unit has analyzed where a stepped transition from one surface to at least one neighboring surface has been detected. This means that a combination of the information from surfaces of maximum reflection and from surfaces that are separated from each other by a step allows generating a representation with sharp contours of the object detected on the body of the inspected person. This representation substantially consists of dot sequences. In order to generate a linear representation, i.e. a representation with sharp contours of the object, the edges of the surface can be traced relatively precisely by means of a corresponding algorithm. The object that has been specified in this respect is then extracted from the image and projected onto a photographic representation of the inspected person including the clothes, i.e. in the exact place where e.g. the weapon is located. This image is then presented to the screener on a monitor, in order to decide whether it is a weapon or a harmless object. In this context, running the extracted object through an object identification program can also be provided, in order to be able to determine the probability of the object being a gun for example and if necessary which type of gun.

### LIST OF REFERENCE NUMBERS

1 three sensors

2 person

5 different emitters

1-10. (canceled)

11. A method for visualization of three-dimensional objects on a person, the method comprising:
emitting an electro-magnetic radiation toward a person;
receiving an electro-magnetic radiation reflected by the person;
processing the reflected radiation to obtain a three-dimensional representation in a form of an elevation profile of the person;
wherein when
a) the elevation profile has a detected surface with a reflection coefficient that is different from a reflection coefficient of at least one neighboring surface; and
b) the detected surface has a stepped transition toward at least one neighboring surface;
then, the object characterized by the detected surface is projected onto a photographic representation of the person in the place where the detected surface has been detected.

12. A method for visualization of three-dimensional objects on a person according to claim 1, wherein:
the processing of the reflected radiation is by means of multistatic scanning of the Fourier space and topographic reconstruction.

13. A method for visualization of three-dimensional objects on a person according to claim 1, wherein:
the detected surface is contoured by way of an edge detection method.

14. A method for visualization of three-dimensional objects on a person according to claim 1, wherein:
the photographic representation is a 2-dimensional image.

15. A method for visualization of three-dimensional objects on a person according to claim 1, wherein:
a three-dimensional image of the person is generated by superimposing a 2-dimensional photographic representation of the person onto a 3-D representation as an elevation profile of a person;
wherein the object characterized by the detected surface is projected onto the three-dimensional image.

16. A method for visualization of three-dimensional objects on a person according to claim 1, wherein:
the detected surface of the elevation profile is substantially flat shaped.

17. A method for visualization of three-dimensional objects on a person according to claim 1, wherein:
the detected surface is a surface that exhibits a maximum value in the elevation profile.

18. A method for visualization of three-dimensional objects on a person according to claim 1, wherein:
the electro-magnetic radiation is in the millimeter or sub-millimeter wave band.

19. A method for visualization of three-dimensional objects on a person according to claim 1, wherein:
a stepped transition is a transition in which a distance in height between the a place on the detected surface and a place on the at least one neighboring surface is greater than a lateral distance between the two places.

20. A method for visualization of three-dimensional objects on a person according to claim 1, further comprising:
determining the type of the object by submitting a contour of the detected surface to an automatic object detection method.

21. A device for visualization of three-dimensional objects on a person, the device comprising:
at least one emitter and one receiver for electro-magnetic radiation;
the emitter emitting an electro-magnetic radiation toward a person to be inspected and the receiver receiving the electro-magnetic radiation reflected by the person;
a computer unit, the computer unit generating a three-dimensional image of the person in the form of an elevation profile by means of multistatic scanning of the Fourier space and topographic reconstruction.
